(19) United States
(12) Patent Application Publication
(10) Pub. No.: US 2002/0116445 A1
(43) Pub. Date: Aug. 22, 2002

(54) Method for interfacing between a switching system and an MMI/TMN agent

(75) Inventor: Ji-Hoon Huh, Gunpo-si (KR)

Correspondence Address: FLESHNER & KIM, LLP, P.O. Box 221200, Chantilly, VA, 20153-1200, US

(73) Assignee: LG Electronics Inc.

(21) Appl. No.: 10/012,458

(22) Filed: Dec. 12, 2001

(30) Foreign Application Priority Data
Dec. 15, 2000 (KR) 2000-77275

(51) Int. Cl. G06F 15/16

(52) U.S. Cl. 709/202

(57) ABSTRACT

The present invention relates to a method for interfacing between a switching system and a Man Machine Interface (MMI)/Telecommunication Management Network (TMN) agent, by which the MMI/TMN agent may be connected to the switching system through an MMI interface block. The method includes interfacing between the switching system and the TMN agent, where the TMN agent transmits, using an MMI input packet, a TMN operator command received from a network management center to an MMI interface block that is connected to application blocks. The TMN agent receives, using an MMI output packet, the result of the TMN operator command, processed by the application blocks, via the MMI interface block. The method further includes interfacing between the switching system and the MMI, where the MMI transmits, using the MMI input packet, an MMI operator command that is inputted from an MMI operator to the MMI interface block. The MMI receives, using the MMI output packet, the result of the MMI operator command, processed by the application blocks, via the MMI interface block. The application blocks are connected to external operators through a single interface. Consequently, the application blocks have a conspicuously lightened load and the operational consistency between the MMI operator and the TMN operator may be maintained.

### BACKGROUND OF THE INVENTION

1. Field of the Invention

The present invention relates to a method for interfacing between a switching system and a Man Machine Interface (MMI)/Telecommunication Management Network (TMN) agent. In particular, the present invention relates to a method for interfacing the MMI/TMN agent to the switching system through an MMI interface block.

2. Background of the Related Art

Generally, a switching system contains various application blocks that perform the switching functions, such as the call setting, data transmission, and call release, etc. The operator operates the switching system using either one of the following two major methods.

With the first method, an operator inputs commands through an operator MMI, and the MMI receives the execution results of the commands or relevant state messages. With the second method, the TMN concept may be used such that an operator regulates the switching systems in a concentrated manner at a network management center that connects many switching systems.

FIG. 1 is a diagram illustrating a related art interface between a switching system and an MMI/TMN agent. The application blocks (13) are interfaced directly to a TMN agent (30) and thus process TMN operator commands transferred from the TMN agent (30). The application blocks (13) are interfaced to an MMI (20) through an MMI interface block (15). Thus, MMI operator commands transferred from the MMI (20) via the MMI interface block (15) are processed by the application blocks (13).

Accordingly, the related art application blocks (13) must be equipped with a function for replying to operator commands transferred from the MMI (20) and an interface to connect with the MMI interface block (15). Also, the related art application blocks (13) must have a function for processing TMN operator commands transferred through the TMN agent (30), wherein the TMN agent (30) is the medium for connecting with the network management center. Additionally, the related art application blocks (13) must have an interface for connecting with the TMN agent (30).

FIG. 2 is a flow chart illustrating the related art method for interfacing between a switching system and an MMI/TMN agent. In the case that TMN operator commands are executed through the TMN agent (30), the TMN agent (30) transfers the TMN operator commands, received from the network management center, directly to the relevant application blocks (13) of the switching system (10) through its own interface, such as an Inter Process Communication (IPC) interface (S10). In step S10, the application block (13) that received the TMN operator commands directly from the TMN agent (30) executes the TMN operator commands and then transmits the execution result of the TMN operator commands directly to the TMN agent (30) (S12).

On the other hand, in the case that the operator inputs commands through the MMI (20), the MMI (20) transfers the MMI operator commands, inputted from the operator to the MMI interface block (15) in the switching system (10), through its own interface (S14). In step S14, the MMI interface block (15) that received the MMI operator commands from the MMI (20) transmits the MMI operator commands to the relevant application blocks (13) through its own interface (S16). Thereafter, the application block (13) that received the MMI operator commands from the MMI interface block (15) executes the received MMI operator commands and then transmits the execution result to the MMI interface block (15) (S18). The MMI interface block (15) receives the MMI operator command execution result from the application block (13) and transmits the execution result to the MMI (20) (S20).

As explained above, many application blocks (13) in the related art switching system (10) must have the interface for connecting with the TMN agent (30) and the interface for connecting with the MMI interface block (15). Therefore, the application blocks (13) must contain lengthy and complex programs because they must process two types of interface and thus suffer the problem of the heavy load.

Moreover, because the interface for connecting with the TMN agent (30) and the interface for connecting with the MMI interface block (15) are respectively established in the related art method, any change in the function of one interface may require the modification in the other interface system. Thus, a great amount of effort is required for the maintenance and management of the application blocks (13).

For example, previously, a program may have been set to output the state values of A, B and C if a state command for outputting the state of a switching system is inputted. Here, if the MMI program is modified so that the output values are to be the state values of A, B, C and D in accordance with input of the state command, the TMN program must be modified in the same way. Otherwise, the TMN operator and the MMI operator may obtain different results for the same command and thus an operational inconsistency may be caused.

In other words, as mentioned above, if the MMI program is modified and the TMN agent program is not, the MMI operator will obtain the state values for A, B, C and D in accordance with a state command input but the TMN operator will obtain the state values for only A, B and C. Thus, the inconsistency in the operation is incurred.

For the purpose of resolving such problems, an interface device between a TMN agent and an MMI and a system management method using the interface device were introduced in Korean Patent Publication No. 2001-38494. As shown in FIG. 3, the TMN agent (30) is connected to the MMI interface block (15) of the switching system (10) through an MMI (20). In this method of connecting the TMN agent (30) to the switching system (10), however, if there is any fault in the MMI (20), the TMN agent (30) cannot be connected to the switching system (10).

Moreover, because the TMN agent (30) is connected to the switching system (10) through the MMI (20), the MMI (20) must analyze and convert the request message of the TMN agent (30) and then transfer it to the switching system (10). Also, the MMI (20) must analyze and convert the result message transmitted from the switching system (10) and then transfer it to the TMN agent (30).

Additionally, in order for the MMI (20) to be able to process the job of the TMN agent (20), the MMI (20) must be constructed with expensive equipment having high performance and stability.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

In order to resolve the above-described problems, the present invention provides a method for interfacing between a switching system and an MMI/TMN agent so that the MMI and the TMN agent may respectively be connected to the switching system through an MMI interface block using the standard input and output packet.

To achieve these and other advantages and in accordance with the purpose of the present invention as embodied and broadly described, a method for interfacing between a switching system and an MMI/TMN agent comprises interfacing between the switching system and the TMN agent. The TMN agent transmits, using an MMI input packet, a TMN operator command received from a network management center to an MMI interface block, which is connected to application blocks. The TMN agent receives, using an MMI output packet, the result of the TMN operator command, processed by the application blocks, via the MMI interface block. Also, the method interfaces between the switching system and the MMI so that the MMI transmits, using the MMI input packet, an MMI operator command inputted from an MMI operator to the MMI interface block and receives, using the MMI output packet, the result of the MMI operator command processed by the application blocks via the MMI interface block.

Here, the MMI input packet includes a command number indicating the number of an input command, an input port number identifying an input port, a job ID identifying the input command, and a signal ID indicating the inherent signal number of the input command. Also, the MMI input packet may further include a data type indicating the type of data, an operation type indicating the type of operation, a processor ID indicating the number of the processor that is to process the input command, and a process ID identifying the relevant process in the MMI interface block.

On the other hand, the MMI output packet includes a data number indicating the number of output data, an input port number identifying an input port, a job ID identifying an input command, a message type identifying the type of message, and a flag identifying a message operation. The MMI output packet may further include a data type indicating the type of data, an operation type indicating the type of operation, an ack_time indicating the time-out period until the next message's arrival, a unit indicating the unit of the ack_time, an output date and time indicating the time when the message is outputted, and a process ID identifying the relevant process in the MMI interface block.

Interfacing between the switching system and the TMN agent includes transmitting the TMN operator command, received from the network management center, to the MMI interface block using the MMI input packet in the TMN agent; transmitting the TMN operator command, received through the MMI input packet, to the application block in the MMI interface block; executing the received TMN operator command in the application block and then transmitting the execution result to the MMI interface block; and transmitting the execution result received from the application block to the TMN agent using the MMI output packet in the MMI interface block.

Interfacing between the switching system and the MMI includes transmitting the MMI operator command, inputted by the operator, to the MMI interface block using the MMI input packet in the MMI; transmitting the MMI operator command, received through the MMI input packet, to the application block in the MMI interface block; executing the received MMI operator command in the application block and then transmitting the execution result to the MMI interface block; and transmitting the execution result received from the application block to the MMI using the MMI output packet in the MMI interface block.

In one embodiment of the present invention, a method for interfacing between a switching system and an MMI/TMN agent includes interfacing the TMN agent and the MMI to an MMI interface block of the switching system through a single standardized interface, and interfacing application blocks of the switching system to the TMN agent and the MMI through the MMI interface block.

Here, interfacing the TMN agent and the MMI to an MMI interface block of the switching system includes transmitting a TMN operator command and an MMI operator command to the MMI interface block using an MMI input packet in the TMN agent and the MMI and receiving a TMN operator command execution result and an MMI operator command execution result from the MMI interface block using an MMI output packet in the TMN agent and the MMI.

Interfacing application blocks of the switching system to the TMN agent and the MMI includes transmitting to the application blocks a TMN operator command and an MMI operator command transmitted from the TMN agent and the MMI through the MMI input packet and executing the TMN operator command and the MMI operator command in the application blocks and then transmitting the execution result to the MMI interface block.

The MMI input packet includes a command number indicating the number of an input command, a data type indicating the type of data, an operation type indicating the type of operation, an input port number identifying an input port, a job ID identifying the input command, a signal ID indicating the inherent signal number of the input command, a processor ID indicating the number of the processor that is to process the input command, and a process ID identifying the relevant process in the MMI interface block.

The MMI output packet includes a data number indicating the number of output data, a data type indicating the type of data, an operation type indicating the type of operation, an input port number identifying an input port, a job ID identifying an input command, a message type identifying the type of message, a flag identifying a message operation, an ack_time indicating the time-out period until the next message's arrival, a unit indicating the unit of the ack_time, an output date and time indicating the time when the message is outputted, and a process ID identifying the relevant process in the MMI interface block.

In another embodiment of the present invention, a method for interfacing between a switching system and an MMI/TMN agent includes receiving a TMN operator command and an MMI operator command from the TMN agent and the MMI using an MMI input packet in an MMI interface block; transmitting the received TMN operator command and the received MMI operator command to application blocks of the switching system; executing the received TMN operator command and the received MMI operator command in the application blocks and transmitting a TMN operator command execution result and an MMI operator command execution result to the MMI interface block; and transmitting the TMN operator command execution result and the MMI operator command execution result received from the application blocks to the TMN agent and the MMI using an MMI output packet.

Here, the MMI input packet includes a command number indicating the number of an input command, a data type indicating the type of data, an operation type indicating the type of operation, an input port number identifying an input port, a job ID identifying the input command, a signal ID indicating the inherent signal number of the input command, a processor ID indicating the number of the processor that is to execute the input command, and a process ID identifying the relevant process within the MMI interface block.

The MMI output packet includes a data number indicating the number of data, a data type indicating the type of data, an operation type indicating the type of operation, an input port number identifying an input port, a job ID identifying an input command, a message type identifying the type of message, a flag identifying a message operation, an ack_time indicating the time-out period until the next message's arrival, a unit indicating the unit of the ack_time, an output time indicating the time when the message is outputted, and a process ID identifying the relevant process within the MMI interface block.

The objects of the invention may be further achieved in whole or in part by a data structure for communicating information from a Man-Machine Interface (MMI) to an MMI block of a switching system and from a Telecommunication Management Network (TMN) agent to the MMI block via the MMI. The data structure includes a command number that identifies a sequence number of an input command, an input port number that identifies an input port, a job identifier that identifies the input command, and a signal identifier that indicates a signal number of the input command.

The objects of the invention may be further achieved in whole or in part by a data structure for communicating information from a Man-Machine Interface (MMI) block of a switching system to an MMI and from the MMI block to a Telecommunication Management Network (TMN) agent via the MMI. The data structure includes a data number that identifies a sequence number of output data, an input port number that identifies an input port, a job identifier that identifies an input command, a message type that identifies a type of message contained in the data structure, and a flag that identifies a message operation.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the related art interface between a switching system and an MMI/TMN agent;

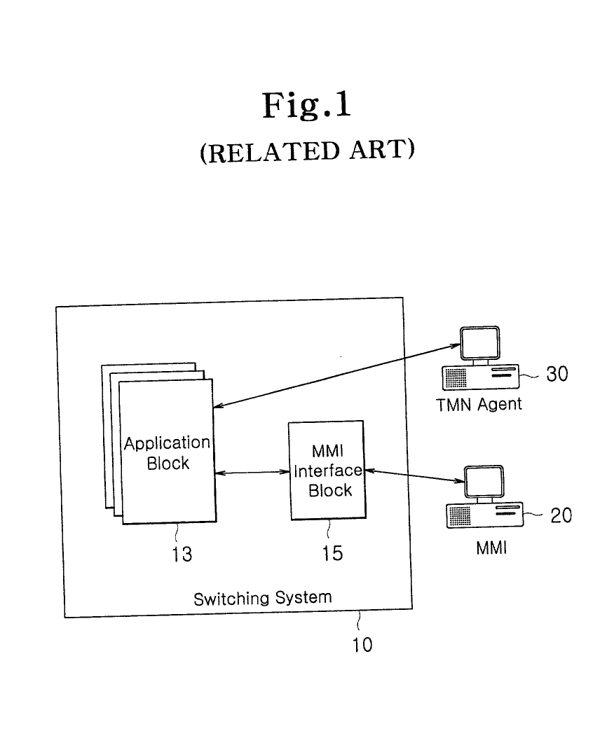

FIG. 2 is a flow chart illustrating the related art method of interfacing between the switching system and the MMI/TMN agent;

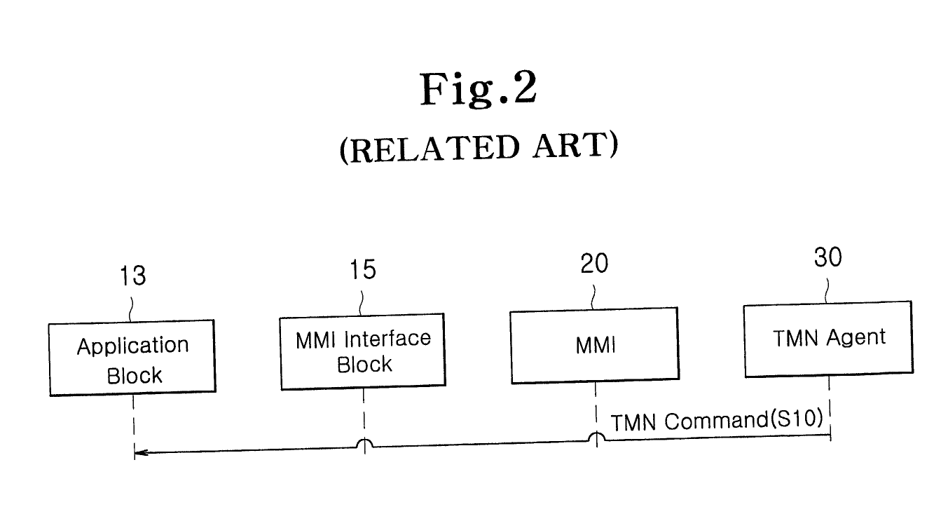

FIG. 3 illustrates the related art interface between the switching system and the MMI/TMN agent, in which the operational inconsistency has been resolved;

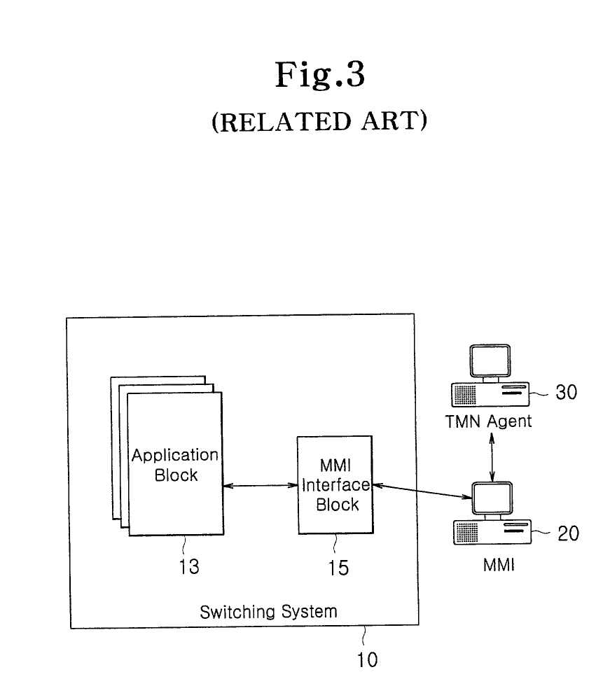

FIG. 4 illustrates an interface between a switching system and an MMI/TMN agent according to a preferred embodiment of the present invention;

FIG. 5 illustrates a structure of the MMI input packet used with the system of FIG. 4;

FIG. 6 illustrates a structure of the MMI output packet used with the system of FIG. 4; and

FIG. 7 is a flow chart illustrating the method of interfacing between the switching system and the MMI/TMN agent according to a preferred embodiment of the present invention.

### DETAILED DESCRIPTION OF PREFERRED EMBODIMENTS

If many application blocks in a switching system are interfaced to an MMI and a TMN agent through different interfaces, as in the related art method, each application block must process two interfaces. Thus, the program tends to become lengthy and complex and the load on the application block becomes heavier. In contrast, according to the present invention, an MMI and a TMN agent are interfaced to the application block through a single interface. Therefore, the load on each application block may be lightened.

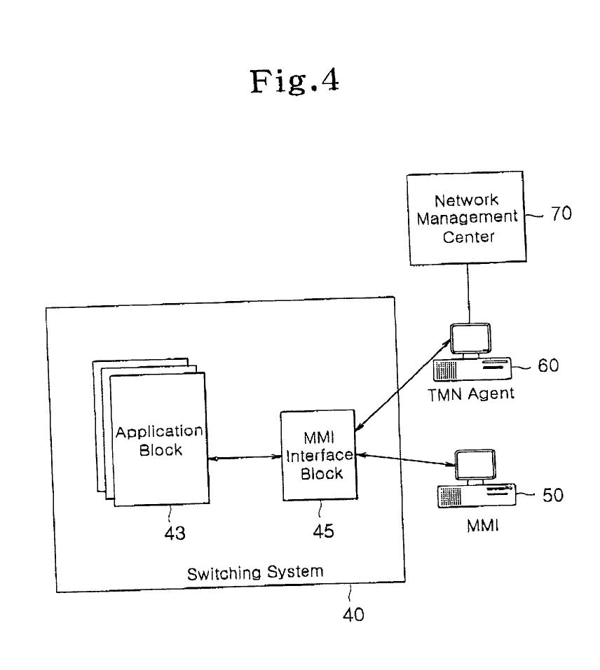

FIG. 4 is a diagram illustrating an interface between a switching system and an MMI/TMN agent according to a preferred embodiment of the present invention. The application blocks (43) performing the switching system's inherent functions, such as call setting, data transmission, and call release, etc., are interfaced to the MMI (50) and the TMN agent (60) through the MMI interface block (45) by a single standard interface, for example, a TCP/IP interface.

The MMI (50) transmits an MMI operator command received from an operator to the MMI interface block (45) by including the MMI operator command in a standard MMI input packet. Additionally, the MMI (50) receives a standard MMI output packet that includes the application block's (43) execution result through the MMI interface block (45). The TMN agent (60) transmits a TMN operator command, received from a network management center (70), to the MMI interface block (45) by including the TMN operator command in the standard MMI input packet. The TMN agent (60) receives the standard MMI output packet, which includes the application block's (43) execution result, from the MMI interface block (45).

The MMI interface block (45) transmits to the application block (43) the standard MMI input packet, including the MMI operator command and a TMN operator command, which has been transmitted from the MMI (50) and the TMN agent (60), and transmits the standard MMI output packet received from the application block (43) to the MMI (50) and the TMN agent (60).

The application block (43), which received the standard MMI input packet through the MMI interface block (45), executes the MMI operator command and TMN operator command included in the standard MMI input packet. Thereafter, the application block (43) includes the execution result in the standard MMI output packet and transmits the output packet to the MMI interface block (45).

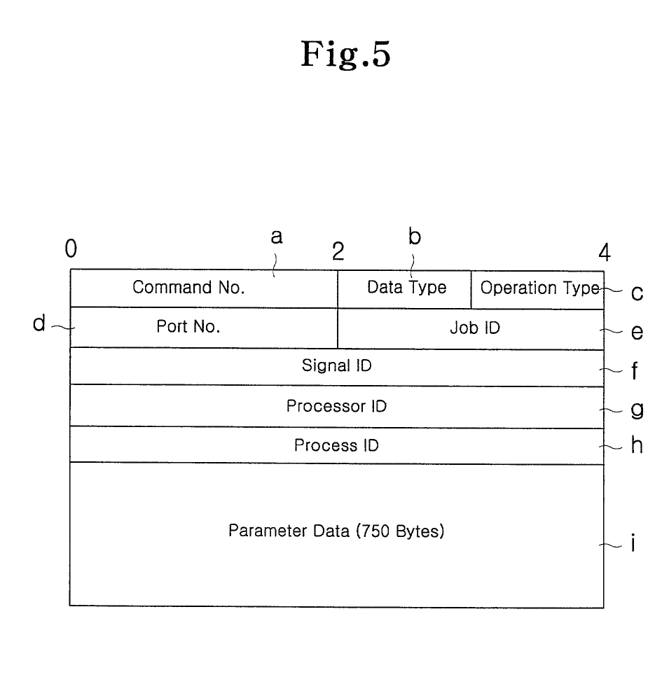

FIG. 5 is a diagram illustrating a structure of the standard MMI input packet used with the system of FIG. 4. The standard MMI input packet comprises: (a) a command number field; (b) a data type field; (c) an operation type field; (d) a port number field; (e) a job ID field; (f) a signal ID field; (g) a processor ID field; (h) a process ID field; and (i) a parameter data field. The detailed explanation is set forth in the following Table 1.

TABLE 1

| Field | Explanation |
|---|---|
| Command | Input command number |
| Number | Range: 0˜9999 |
| Data Type | Number identifying the type, statistics, NO7, fault, etc. |
| | Upon the execution of commands, the result is outputted |
| | to the relevant output port depending on the value of this field. |
| | In case of Man Machine Command (MMC), the input itself is |
| | outputted; In case of ALM (alarm), FLT (fault), or STS |
| | (statistics), the output depends on the data type. |
| | 0: MMC |
| | 1: Structure |
| | 2: Fault |
| | 3: Statistics |
| Operation | Number indicating types of CREATE, SET, GET, NOTI, etc. |
| Type | In case of MMC, the input itself is outputted (0˜4); In case of |
| | ALM, FLT, or STS, the value corresponding to the state |
| | change cause (5˜7) is outputted. |
| | 0: CREATE |
| | 1: DELETE2: SET |
| | 3: ACTION |
| | 4: INITIAL |
| | 5: EVENT-REPORT |
| | 6: EVENT-SYNC |
| | 7: CHANGE |
| | 10: MMC Channel (Command to cease the execution) |
| | 11: DB Query Input Continue |
| | 12: DB Query Input End |
| | 13: DB Query Relation List |
| | 14: DB Query Processor List |
| | 15: DB Query Attribute List |
| Port | Number identifying input port |
| Number | Distinguishes MMI Client, TMN, etc. |
| | 0˜99: Identifies MMI port |
| | 100˜: Identifies TMN port |
| | This number is returned without change. |
| Job ID | Identifies input command |
| | Job ID is used as the ID for identifying commands. |
| | This number is returned without change. |
| Signal ID | Inherent signal number of the relevant command |
| | Each command has an inherent signal number to be |
| | transmitted as a signal to the application block in the |
| | switching system. The number may be known by |
| | MMSSIG.DAT. |
| Processor | Number of the processor to execute the relevant command |
| ID | Each command has an inherent processor number to indicate |
| | the processor in the switching system in which the |
| | command will be executed. |
| | The number may be known by MMSSIG.DAT |
| Process | Field |
| ID | |

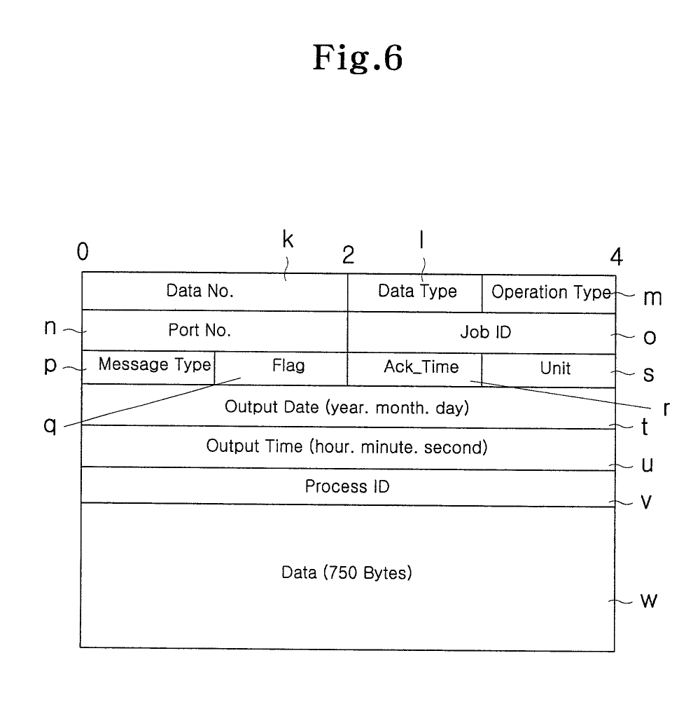

FIG. 6 is a diagram illustrating a structure of the standard MMI output packet used with the system of FIG. 4. The standard MMI output packet used in the present invention comprises: (k) a data number field; (l) a data type field; (m) an operation type field; (n) a port number field; (o) a job ID field; (p) a message type field; (q) a flag field; (r) an ack_time field; (s) a unit field; (t) an output date field; (u) an output time field; (v) a process ID field; and (w) a data field. The detailed explanations of such fields are provided in the following Table 2.

TABLE 2

| Field | Explanation |
|---|---|
| Data | Output data number |
| Number | Range: 0˜9999 |
| Data | Number identifying the type, statistics, NO7, fault, etc. |
| Type | Upon the execution of commands, the result is outputted to |
| | the relevant output port depending on the value of this field. |
| | In case of MMC, the input itself is outputted; In case of ALM |
| | (alarm), FLT (fault), or STS (statistics), the output depends |
| | on the data type. |
| | 0: MMC |
| | 1: Structure |
| | 2: Fault |
| | 3: Statistics |
| Operation | Number indicating types of CREATE, SET, GET, NOTI, etc. |
| Type | In case of MMC, the input itself is outputted (0˜4); |
| | In case of ALM, FLT, or STS, the value corresponding to the |
| | state change cause (5˜7) is outputted. |
| | 0: CREATE |
| | 1: DELETE |
| | 2: SET |
| | 3: ACTION |
| | 4: INITIAL |
| | 5: EVENT-REPORT |
| | 6: EVENT-SYNC |
| | 7: CHANGE |
| | 10: MMC Channel (Command to cease the execution) |
| | 11: DB Query Input Continue |
| | 12: DB Query Input End |
| | 13: DB Query Relation List |
| | 14: DB Query Processor List |
| | 15: DB Query Attribute List |
| Port | Number identifying input port |
| Number | Distinguishes MMI Client, TMN, etc. |
| | 0˜99: Identifies MMI port |
| | 100˜: Identifies TMN port |
| | This number is returned without change. |
| Job ID | Identifies input command |
| | Job ID is used as the ID for identifying commands. |
| | This number is returned without change. |
| Message | Distinguishes the types of messages such as MMC, ALM, |
| Type | FLT, STS, etc. |
| | 1: ALM |
| | 2: FLT |
| | 3: STS |
| | 4: MMC |
| Flag | Distinguishes message operations |
| | MMC_ACK: 1 (This is an acknowledgment of the MMC |
| | command; It means that the next message will arrive within |
| | the ack_time unit; This is used when the time out (the basic |
| | setting is 30 seconds) is extended or when it is responded that |
| | the MMC has been received. |
| | MMC_KILLED: 2 (In the case that the MMC in execution is |
| | terminated.) |
| | SEND_CONTINUE: 3 (This is an output message; This is |
| | followed by messages.) |
| | SEND_END: 4 (This is an output message; but there is not a |
| | following message. In case of MMC, the command is |
| | terminated.) |
| Ack_time | Time out period until the next message arrives |
| Unit | Unit of the ack_time (SEC, MIN, HOUR) |
| | 1: SEC |
| | 2: MIN |
| | 3: HOUR |
| Output | Indicates the time when the message is outputted. |
| Date, | |
| Time | |
| Process | Field |
| ID | |

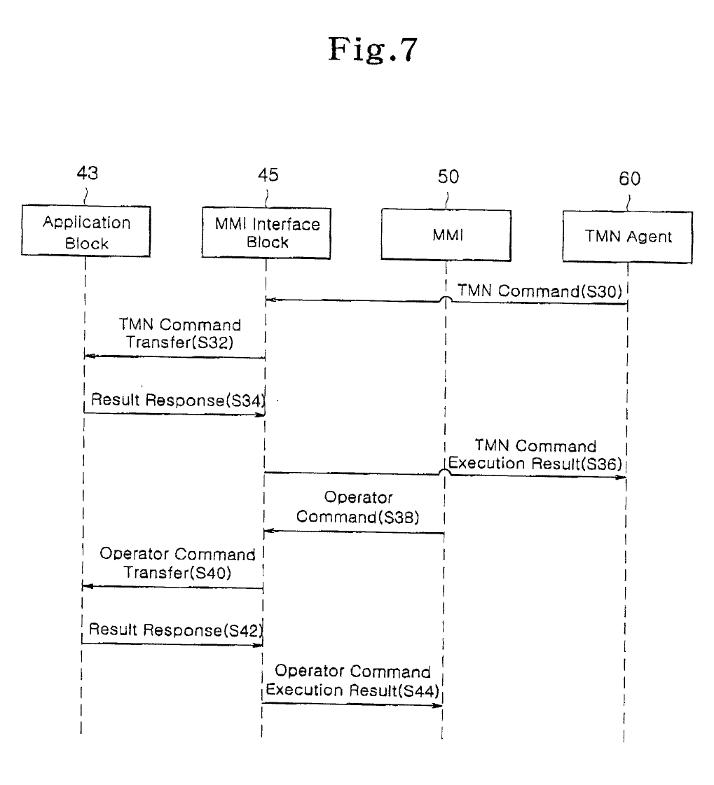

FIG. 7 is a flow chart illustrating the method of interfacing between the switching system and the MMI/TMN agent according to a preferred embodiment of the present invention. The TMN agent (60) includes the TIM operator command received from the network management center (70) in the standard MMI input packet and transmits the standard MMI input packet to the MMI interface block (45) (step S30). The MMI interface block (45) transmits the received TMN operator command to the application block (43) (stepS32). The application block (43) executes the received TMN operator command and transmits the execution result to the MMI interface block (45) (step S32). The MMI interface block (45) includes the received execution result in the standard MMI output packet and transmits the MMI output packet to the TMN agent (60) (step S36). The TMN agent (60) extracts the execution result of the TMN operator command from the standard MMI output packet and transmits the extracted execution result to the network management center (70).

On the other hand, in the case that an operator inputs a command through the MMI (50), the MMI (50) includes the MMI operator command in the standard MMI input packet and transmits the packet to the MMI interface block (45) (step S38). The MMI interface block (45) transmits the received MMI operator command to the application block (43) (step S40). The application block (43) executes the received MMI operator command and transmits the execution result to the MMI interface block (45) (step S42). The MMI interface block (45) includes the received execution result in the standard MMI output packet and transmits the packet to the MMI (50) (step S44). The MMI (50) extracts the execution result of the MMI operator command from the standard MMI output packet and makes the extracted result available for the operator's review, through a Graphical User Interface (GUI).

As described above, according to the present invention's method for interfacing between a switching system and an MMI/TMN agent, an MMI and a TMN agent are interfaced to an MMI interface block through a single standard interface using a standard MMI input packet and a standard MMI output packet. Thus, the application blocks in the switching system are connected to external operators through one type of standard interface.

Consequently, compared with the related art method of using various different interfaces, the application blocks have a conspicuously lightened load. Furthermore, in contrast to the related art method, which requires for operational consistency the modification of the other part's function when there is any change in the function of one part, the present invention may obtain the desired change in function without modifying the other part's function. Accordingly, the MMI operator and the TMN operator may maintain operational consistency.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of interfacing with a switching system, comprising:
transmitting a Telecommunication Management Network (TMN) operator command from a TMN agent to a Man-Machine Interface (MMI) block, using an MMI input packet;
transmitting a result of the TMN operator command, processed by an application block, from the MMI block to the TMN agent, using an MMI output packet;
transmitting an MMI operator command from an MMI to the MMI block, using the MMI input packet; and
transmitting a result of the MMI operator command, processed by the application block, from the MMI block to the MMI, using the MMI output packet.

2. The method of claim 1, wherein the MMI input packet comprises:
a command number indicating a number of an input command;
an input port number identifying an input port;
a job ID identifying the input command; and
a signal ID indicating an inherent signal number of the input command.

3. The method of claim 2, wherein the MMI input packet further comprises:
a data type that indicates a type of data;
an operation type that indicates a type of operation;
a processor ID that identifies a processor to process the input command; and
a process ID that identifies a process in the MMI block.

4. The method of claim 1, wherein the MMI output packet comprises:
a data number that indicates a sequence number of output data;
an input port number that identifies an input port;
a job ID that identifies an input command;
a message type that identifies a type of message; and
a flag that identifies a message operation.

5. The method of claim 4, wherein the MMI output packet further comprises:
a data type that indicates a type of data;
an operation type that indicates a type of operation;
an ack_time that indicates a time-out period until a next message's arrival;
a unit identifier that indicates a unit of the ack_time;
an output date and time that indicates a time when the message is outputted; and
a process ID that identifies a process in the MMI block.

6. The method of claim 1, further comprising:
transmitting the TMN operator command received through the MMI input packet to the application block; and
executing the received TMN operator command in the application block and then transmitting the execution result of the TMN operator command to the MMI block.

7. The method of claim 1, further comprising:
transmitting the MMI operator command received through the MMI input packet to the application block; and
executing the received MMI operator command in the application block and then transmitting the execution result of the MMI operator command to the MMI block.

8. A method for interfacing with a switching system, comprising:
interfacing a Telecommunication Management Network (TMN) agent and a Man-Machine Interface (MMI) to an MMI block of the switching system through a single standardized interface; and
interfacing application blocks of the switching system to the TMN agent and the MMI through the MMI block.

9. The method of claim 8, further comprising:
transmitting a TMN operator command and an MMI operator command to the MMI block using an MMI input packet; and
receiving a TMN operator command execution result and an MMI operator command execution result from the MMI block using an MMI output packet.

10. The method of claim 8, further comprising:
transmitting to the application blocks a TMN operator command and an MMI operator command transmitted from the TMN agent and the MMI, respectively, using an MMI input packet; and
executing the TMN operator command and the MMI operator command in the application blocks and then transmitting the execution result to the MMI block.

11. The method of claim 9, wherein the MMI input packet comprises:
a command number that indicates a sequence number of an input command;
a data type that indicates a type of data;
an operation type that indicates a type of operation;
an input port number that identifies an input port;
a job ID that identifies the input command;
a signal ID that indicates an inherent signal number of the input command;
a processor ID that identifies a processor that is to process the input command; and
a process ID that identifies a process in the MMI block.

12. The method of claim 9, wherein the MMI output packet comprises:
a data number that indicates a sequence number of output data;
a data type that indicates a type of data;
an operation type that indicates a type of operation;
an input port number that identifies an input port;
a job ID that identifies an input command;
a message type that identifies a type of message;
a flag that identifies a message operation;
an ack_time that indicates a time-out period until a next message's arrival;
a unit identifier indicates a unit of the ack_time;
an output date and time that indicates a time when the message is outputted; and
a process ID that identifies a process in the MMI block.

13. A method for interfacing a switching system, comprising:
receiving a Telecommunication Management Network (TMN) operator command and Man-Machine Interface (MMI) operator command from a TMN agent and a MMI, respectively, using an MMI input packet;
transmitting the received TMN operator command and the received MMI operator command from an MMI block to application blocks of the switching system; and
at least one of:
executing the received TMN operator command and the received MMI operator command in the application blocks and transmitting a TMN operator command execution result and an MMI operator command execution result to the MMI block, and
transmitting the TMN operator command execution result and the MMI operator command execution result received from the application blocks to the TMN agent and the MMI using an MMI output packet.

14. The method of claim 13, wherein the MMI input packet comprises:
a command number that indicates a sequence number of an input command;
a data type that indicates a type of data;
an operation type that indicates a type of operation;
an input port number that identifies an input port;
a job ID that identifies the input command;
a signal ID that indicates an inherent signal number of the input command;
a processor ID that identifies a processor that is to execute the input command; and
a process ID that identifies a process within the MMI block.

15. The method of claim 13, wherein the MMI output packet comprises:
a data number that indicates a sequence number of data;
a data type that indicates a type of the data;
an operation type that indicates a type of operation;
an input port number that identifies an input port;
a job ID that identifies an input command;
a message type that identifies a type of message;
a flag that identifies a message operation;
an ack_time that indicates a time-out period until a next message's arrival;
a unit identifier that indicates a unit of the ack_time;
an output time that indicates a time when the message is outputted; and
a process ID that identifies a process within the MMI block.

16. A data structure for communicating information from a Man-Machine Interface (MMI) to an MMI block of a switching system and from a Telecommunication Management Network (TMN) agent to the MMI block via the MMI, comprising:
a command number that identifies a sequence number of an input command;
an input port number that identifies an input port;
a job identifier that identifies the input command; and
a signal identifier that indicates a signal number of the input command.

17. The data structure of claim 16, further comprising:
a data type that indicates a type of data contained within the data structure;
an operation type that indicates a type of operation to be performed by the switching system;
a processor identifier that identifies a processor of the switching system that is to process the input command; and
a process identifier that identifies a process to be performed by the switching system.

18. A data structure for communicating information from a Man-Machine Interface (MMI) block of a switching system to an MMI and from the MMI block to a Telecommunication Management Network (TMN) agent via the MMI, comprising:
a data number that identifies a sequence number of output data;
an input port number that identifies an input port;
a job identifier that identifies an input command;
a message type that identifies a type of message contained in the data structure; and
a flag that identifies a message operation.

19. The data structure of claim 18, further comprising:
a data type that indicates a type of data contained within the data structure;
an operation type that indicates a type of operation performed by the switching system;
an ack_time that indicates a time-out period for an arrival of a next message;
a unit identifier that indicates a unit of the ack_time;
an output date and time that indicates a time when the message is outputted; and
a process identifier that identifies a process performed by the switching unit.

20. The method of claim 1, wherein:
the TMN operator command is originated by a network management center and communicated to the TMN agent; and
the MMI operator command is communicated to the MMI by an MMI operator.
